(19) United States
(12) Patent Application Publication
(10) Pub. No.: US 2004/0055216 A1
(43) Pub. Date: Mar. 25, 2004

(54) Method for gasifying materials containing carbon such as waste or coal containing sulphur

(76) Inventors: Bruno Berger, Braunau (AT); Ernst Rudelstorfer, Maria Enzersdorf (AT)

Correspondence Address: YOUNG & THOMPSON, 745 SOUTH 23RD STREET 2ND FLOOR, ARLINGTON, VA, 22202

(21) Appl. No.: 10/344,315

(22) PCT Filed: Jul. 19, 2001
(86) PCT No.: PCT/AT01/00245

(30) Foreign Application Priority Data
Aug. 11, 2000 (AT) A 1393/2000

(51) Int. Cl. C01B 3/32

(52) U.S. Cl. 48/197 FM; 48/77; 48/63; 48/101; 48/210; 48/202; 48/209

(57) ABSTRACT

According to a method for gasifying solid materials (waste materials, biomass (wood), coal containing sulphur) in a fluidized bed (5), water vapour and oxygen are blown into the fluidized bed as gasifying agents. Small energy losses are achieved by strongly superheating the water vapour with hot reaction gases, the superheater functioning with a low differential pressure load. The reaction gases that leave the fluidized bed (5) are post-gasified in the open area (9) above the fluidized bed (5) in the reactor (1), with a supply of additional oxygen. A molar ratio of water vapour supplied and carbon contained in the material to be gasified of at least 2.1 is established.

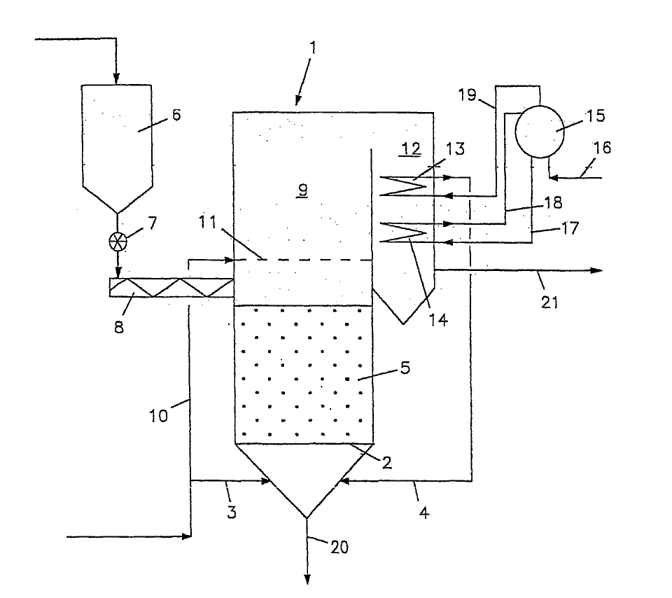

The invention relates to a process for gasification of carbonaceous (elemental or chemical bounded carbon) materials in particular solid materials with the characteristics of the introductory part of the independent claim 1. For example solid wastes, biomass such like wood, or sulfur-containing coals or mixtures of such materials can be gasified in a fluidised bed whereby steam and oxygen are introduced into the fluidised bed as gasifying agents.

In a prior art process for the gasification of carbonaceous materials steam is introduced into the fluidised bed in a quantity that result in a molar ratio of introduced steam to carbon contained in the solid waste of 0.37 to 0.62 as described by Scharpff, Jens-Tilo (“Vergasung von Kunststoffen und backender Steinkohle in der Wirbelschicht”, Berichte aus der Eisenhüttenkunde, Band 9/95, Rheinisch-Westfälische Technische Hochschule Aachen).

In the prior art processes the heat recovery due to reasons of high temperature corrosion is not carried out at highest temperature level. At reducing atmosphere conditions present at the gasification and in presence of chlorine and sulfur in the reaction gas high temperature resistant nickel alloyed materials are damaged at wall temperatures above 540° C. The prior art processes therefore use the hot out flowing reaction gas first for the generation of saturated steam at comparable low temperature level.

From U.S. Pat. No. 4,359,326 A a process of the kind described in the introduction is known.

It is the object of the invention to provide a process of the kind described in the introduction whereby the disadvantages of the prior art processes do not appear and the heat recovery is improved.

The objective is solved by the invention by means of a process having the characteristics of claim 1.

Preferred and advantageous embodiments of the invention are subject of the depended claims.

In the process of this invention the reaction gases flowing out from the reaction chamber at high temperatures (these can have temperatures in the range of 1000° C.) to superheat and/or to generate steam. Thus the total power consumption for the operation of the process of this invention can be maintained within limits although more steam is introduced in comparison to the prior art.

The superheating of steam by the hot reaction gases to temperatures above 540° C. is supported by the process of this invention by a small pressure difference from one to the other side of the heat exchange surface. In the process of this invention the differential pressure is maintained at low values that is for example less than 1000 mbar preferably less than 500 mbar. Beside the corrosive attack only small mechanical strains are present at the heat exchange surface. Due to the small mechanical strains it is not required to use high stress resisting materials such as nickel alloyed steels or nickel alloys and high temperature corrosion resisting materials such as Cr—Mo steels or ceramic materials can be used.

Another disadvantage of the processes of the prior art is that the gasification is not complete and the reaction gas contains higher organic carbon compounds such as aromatics (naphthalene) phenols and tars.

In the process of this invention an efficient and complete gasification of materials such as solid waste for example municipal solid waste, selected hazardous waste, biomasses (wood and the like) or sulfur-containing coal is possible. This is accomplished by a gasification process for solid materials in which the molar ratio of steam introduced into the fluidised bed to carbon contained in the material to be gasified is adjusted to at least 2.1.

Because in the process of this invention a molar ratio of introduced steam to carbon (elemental or chemically bonded) contained in the material to be gasified or carbon eventually additionally added is maintained at a value of at least 2.1 the cracked compounds of the waste material do not recombine to heavy compounds and a more clean reaction gas is generated in comparison to prior art processes.

The molar ratio of introduced steam to carbon contained in the material to be gasified can be increased in the process of this invention up to 4.0 more in particular up to 3.5.

In the process of this invention the in comparison to prior art processes increased flow rate of steam introduced yield a more clean reaction gas whereby the increased power requirement which is required for the generation of the steam can be compensated at least to a part that the enthalpy of the introduced steam maintains the fluidised bed at a temperature advantageous to the operation of the process of this invention and heats up the material to be gasified to this temperature.

For the process of this invention oxygen can be introduced as air, as oxygen-enriched air or as technically pure oxygen.

The type of the fluidised bed for the process of this invention is at discretion. So, bubbling fluidised beds or circulating fluidised beds can be used whereby a bubbling fluidised bed is preferred since sufficient residence times are permitted and downstream dust collectors (cyclones) are dispensable.

In the reaction chamber a sub-atmospheric pressure or a positive pressure can be maintained during operation of the process of this invention. Sub-atmospheric pressures are generally between 15 and 5 mbar, preferably at 10 mbar. Positive pressures usually are adjusted to a value within 100 mbar to 5 bars.

Additional details, features and advantages of the process of this invention are provided in the description of examples for the process of this invention hereafter and in which it is referred to the appended drawing.

The drawing illustrates a schematic of a process unit by which the process of this invention can be practiced.

In a fluidised bed reactor 1 in the lower section a distribution plate 2 is foreseen which can be constructed for example in the form of a pipe distributor. At the distribution plate 2 the line 3 for the introduction of oxygen and the line 4 for the introduction of superheated steam terminate at the reactor 1. Above the distribution plate 2 the fluidised bed 5 is situated. The materials to be gasified such as solid wastes or sulfur-containing coals are charged from the charge bin 6 past the rotary vane 7 and the screw conveyor 8 into the reactor 1 somewhat above the top level of the fluidised bed 5 which has the preferred type of a bubbling fluidised bed 5.

In the region 9 of the reactor chamber 1 which is situated above the fluidised bed 5 and where the after-gasification takes place an oxygen line 10 terminates in the region 9, whereby the introduced oxygen exits into the region 9 through nozzles 11 arranged all at one level.

The reaction gases leaving reactor 1 at a temperature of for example 1050° C. enter the chamber 12 where the steam super heater 13 and the steam generator 14 are situated. The steam generator 14 is provided from the steam drum 15 with boiler feed water through line 17, the steam drum 15 is charged with boiler feed water through line 16. Steam generated in steam generator 14 is returned to steam drum 15 through line 18. Steam from steam drum 15 flows to steam super heater 13 through line 19. The exit of steam super heater 13 from which steam flows out having a temperature of for example 800° C. is connected to line 4.

Reaction gas 21 is leaving chamber 12 through line 21 and is transferred by line 21 to further use.

Ash can be removed out of reactor 1 at the bottom by a lock of line 20.

Wastes from municipal solid waste or selected hazardous waste are preprocessed whereby metals stones and glass are removed. During preprocessing and if necessary, a particle size standardization to particle sizes suitable for conveying takes place, particle sizes having preferentially between 6 mm and 60 mm, by shredding of oversized particles and agglomeration of undersized particles.

Further a thermal treatment of the waste materials is preferred to dry and reduce the moisture content of the waste materials.

For the gasification of sulfur-containing coal the preparation is done by grinding of the feed material. Due to the slower gasification reaction kinetics of coal a small particle size is required.

The in particle sized preprocessed materials to be gasified are introduced into the fluidised bed 5 for example by way of lock 7 and screw conveyor 8.

If waste materials are from classified collection of thermoplastic type materials the preprocessing to particles can be left out since thermoplastics can be liquefied and directly pressure fed into the reactor 1.

Die gasification takes place in the fluidised bed 5 by addition of superheated steam and oxygen whereby the addition occurs through distributor plate 2 of the fluidised bed 5. This can be accomplished by mixing oxygen (or air or oxygen-enriched air) with the steam in the steam header. In the fluidised bed 5 the bulk material of fine grain particles is fluidised by the up-flowing gas (oxygen and steam) and suspended. Advantages of a fluidised bed are amid others the uniform bed temperature due to the intensive stirring and the easy conveying of solids due to the liquid-like flow behavior of the fluidised bed 5.

The fluidised bed 5 is made up generally by inert quartz sand or by not yet gasified coal particles in case of the gasification of sulfur-containing coal.

To bind acidic sulfur and chlorine components of the waste materials to the ash stream limestone can be added to the fluidised bed 5.

After the gasification of the materials ash and non-combustible materials are removed by a lock from the fluidised bed 5 at the distributor plate 2.

Steam is introduced to the fluidised bed 5 in excess quantities (in relation to the carbon content of the materials to be gasified) and serves simultaneously as fluidisation agent for the fluidised bed 5. Oxygen is introduced in sub-stoichiometric quantities (in relation to the carbon content of the materials to be gasified) namely at a flow rate necessary to reach desired temperature in the fluidised bed 5. Since it is preferred to introduce large quantities of rigorously superheated steam (high temperature steam) the addition of oxygen can be kept at relative low values.

Due to the surplus of steam in the fluidised bed 5 thermally cracked compounds of the materials to be gasified do not recombine to heavy compounds and a clean reaction gas is generated.

The maximum attainable temperature of the fluidised bed 5 is determined by components—mainly of inorganic materials—of the materials to be gasified. Above a critical temperature typical to the type of components the materials soften and lead to the sticking of the fluidised bed 5.

In the process of this invention it is preferred to operate at a temperature whereby the critical temperature typical to the type of components is not reached.

At the temperatures attainable in the fluidised bed 5 chemically very stable compounds such as aromatics, certain nitrogen or halogen compounds will not or only partially be destroyed (cracked). For this reason the gas leaving the fluidised bed 5 is conducted to an after-gasification step. The after-gasification is carried out in the freeboard 9 above the fluidised bed 5 whereby additional oxygen is introduced. For this nozzles 11 are provided above the fluidised bed 5 where additional oxygen is injected. By the introduction of additional oxygen the reaction temperature is further increased and in combination with a sufficient residence time chemically not anymore stable compounds will be also cracked to light gaseous compounds and to elemental hydrogen.

Within the scope of the invention the cooling down of the reaction gas is combined with the generation of superheated steam being advantageous for the process of this invention. During the cooling down of the reaction gases too the presence of excess steam in the reaction gas is advantageous since light cracked products do not recombine into heavy compounds or only to an extend not worth mentioning.

In the downstream purification of the reaction gas the steam is removed by condensation whereby also toxic compounds can be removed thus the generated reaction gas can be used in a gas motor or gas turbine whereby it is possible to meet the specified emission standards.

It is the preferred in the process of this invention to use the enthalpy of the hot reaction gases to heat up steam in the super heater 13 to high temperatures, whereby the heat exchange is taking place at a small pressure difference between steam and reaction gases. The pressure difference is maintained small that is below a value of 1000 mbar by conducting steam from super heater 13 directly to the fluidised bed 5 and from there by conducting the reaction gases generated directly back to super heater 13. The pressure difference between steam and reaction gases at the super heater 13 is therefore made up only by flow pressure drop of line 4 inclusive distribution in distributor plate 2 the flow pressure drop of the fluidised bed 5 and the flow pressure drop back to super heater 13 in chamber 9 and 12. The said equipment contributing to the pressure difference is preferentially designed that in total only a small pressure drop becomes in effect.

To ensure that there is only a small pressure difference in the super heater 13 the pressure of the generated steam is reduced in line 19 before entering the super heater 13. The pressure reduction can be accomplished by a small line size of line 19, a control valve or a steam turbine.

### EXAMPLE

15 Mg/h (metric tons per hour) of preprocessed municipal solid waste having an average elemental composition of

| | | |
|---|---|---|
| H₂ | 6.4 | weight-% |
| N₂ | 0.2 | weight-% |
| C | 46.0 | weight-% |
| O₂ | 34.4 | weight-% |
| H₂O | 10.6 | weight-% |
| S | 0.2 | weight-% |
| Cl₂ (and other halogens) | 0.4 | weight-% |
| Inert inorganic noxious waste | | |
| components (Pb, Cd, Tl, Cr, | | |
| Cu, Ni, Hg, As, Sn, Zn) | 1.7 | weight-% |
| are fed into the fluidised bed 5. | | |

Into the fluidised bed 5 a steam flow rate of 22.2 Mg/h is introduced to obtain a molar ratio of steam to carbon contained in the municipal solid waste of 2.4. The flow rate of introduced steam has been calculated for subject example as shown hereafter:

Molar flow rate of carbon in the feed (municipal solid waste):

15 Mg/h×46%/12 g/mol=0.575 Mmol/h.

Required steam flow rate total:

2.4×0.575 Mmol/h×18.01 g/mol=24.8 Mg/h.

Required steam flow rate to fluidised bed=required steam flow rate total minus water contained in MSW: 24.8 Mg/h−15 Mg/h×10.6%=22.2 Mg/h.

The temperature of the steam introduced into the fluidised bed 5 is 800° C.

The average temperature of the fluidised bed is 650° C. This temperature is attained and maintained by introducing 3.1 Mg/h of oxygen.

To the reaction gas leaving fluidised bed 5 another 3.2 Mg/h of oxygen is added for after-gasification through nozzles 11 so that in the after-gasification region 9 a temperature of the reaction gas of 1050° C. is reached. The after-gasification region 9 is dimensioned to a size to obtain an average residence time of the reaction gas at said temperature of 2 seconds.

The pressure of the reaction gas at the exit of fluidised bed 5 or in the after-gasification region 9 is 140 mbar. From fluidised bed 5 to the inlet of super heater 13 only a hardly measurable pressure drop is found so that also the pressure at the super heater 13 is essentially 140 mbar. The pressure drop over fluidised bed 5 is approximately 110 mbar and over the steam line 4 inclusive distributor plate 2 approximately 35 mbar. The pressure difference in total is therefore 145 mbar or the pressure of the superheated steam at the exit of the super heater 13 is 285 mbar.

The surface for heat transfer of super heater 13 is made of ceramic material or of a nickel-free Cr—Mo alloyed steel providing satisfactory resistance against given high temperature corrosion and strength against given pressure difference. In the case of the ceramic material small leakages of superheated steam to the reaction gas can appear due to porous material joints. The leakages however do not present a problem for the operation of the process.

In the subsequent steam generator 14 the reaction gas is cooled down to about 200° C. The steam generator 14 is made of standard low-alloy boiler steel in accordance with the reduced corrosion attack.

The final cooling down to 35° C. is made by quench with cold water. Thereby the largest part of the steam in the reaction gas together with the noxious compounds is condensed. Small quantities of noxious compounds eventually remaining in the reaction gas can be wash out by a following water or alkaline scrubbing.

The reaction gas having a flow rate of 23,000 m³/h at standard conditions has the hereafter shown composition and heat of combustion after the deduction of remaining moisture:

| | |
|---|---|
| CO | 30.64 % volume |
| H2 | 40.01 % volume |
| CH4 | 3.10 % volume |
| other hydrocarbons | 0.42 % volume |
| CO₂ | 20.36 % volume |
| N₂ | 5.46 % volume |

The heat of combustion of the reaction gas is 68.1 MW.

With the process of this invention solid waste materials which contain carbon or carbon compounds such as preprocessed municipal solid wastes, plastic wastes, industrial wastes, tires, biomass wastes, all containing noxious components can be gasified. The preferred minimum heat of combustion of the solid waste is about 9 MJ/kg. But also solid wastes below the minimum heat of combustion of 9 MJ/kg can be gasified with the process of this invention if carbon as coke or coal is added.

With the process of this invention also sulfur-containing coal or biomass can be gasified.

In summary a preferred example for the invention can be described as follows:

In a process for the gasification of solid materials (solid wastes, biomass (wood), sulfur-containing coal) in a fluidised bed 5 steam and oxygen as gasification agents are blown into the fluidised bed. Low energetic losses are obtained due to a rigorous superheating of steam by hot reaction gases whereby the super heater operates at low differential pressure load. The reaction gases leaving the fluidised bed 5 are after-gasified in the freeboard 9 above the fluidised bed 5 in the reactor 1 by introduction of additional oxygen. Thereby the molar ratio of introduced steam to carbon contained in the material to be gasified is adjusted to at least 2.1.

What is claimed is:

1. A process for the gasification of (elemental or chemically bounded) carbon containing preferentially solid material such as solid wastes, biomass, like wood, or sulfur-containing coal or mixtures of such materials in a fluidised bed whereby the materials to be gasified are heated by in a super heater superheated steam and whereby the pressure difference between the steam exiting the super heater and the reaction gas entering the super heater, which pressure difference assembles the flow pressure drop of the fluidised bed, the distribution plate, and the lines from the super heater to the distribution plate and from the fluidised bed to the super heater, is maintained low characterized in that the molar ratio of steam introduced to the fluidised bed to the carbon contained in the material to be gasified is adjusted to at least 2.1.

2. A process according to claim 1 characterized in that the pressure of the steam before entering the super heater is reduced.

3. A process according to claim 1 or 2 characterized in that the pressure difference is less than 1000 mbar preferably less than 500 mbar.

4. A process according to any one of claims 1 to 3 characterized in that the steam is superheated to a temperature of more than 540° C.

5. A process according to any one of claims 1 to 4 characterized in that the heat exchange surface of the super heater is made of a nickel-free material.

6. A process according to any one of claims 1 to 5 characterized in that the reaction gases after have been used for the superheating of steam are used for the generation of steam.

7. A process according to any one of claims 1 to 6 characterized in that the reaction gases leaving the fluidised bed are after-gasified in an after-gasification region.

8. A process according to any one of claims 1 to 7 characterized in that the introduced steam has a temperature, which is higher than the average temperature of the fluidised bed.

9. A process according to any one of claims 1 to 8 characterized in that the average temperature of the fluidised bed is maintained at 650° C.

10. A process according to any one of claims 1 to 9 characterized in that the steam is introduced at a temperature of 500 to 1000° C., preferably 800° C.

11. A process according to any one of claims 1 to 10 characterized in that the steam in particular superheated steam is used as fluidizing agent.

12. A process according to any one of claims 1 to 11 characterized in that for the gasification of waste materials having a heat of combustion of less than 9 MJ/kg carbon for example as coke or coal is added.

13. A process according to any one of claims 1 to 12 characterized in that the residence time of the, the fluidised bed leaving reaction gases at the after-gasification region in which oxygen is introduced is at least 1 second preferably 2 seconds.

14. A process according to any one of claims 1 to 13 characterized in that the temperature of the reaction gas in the after-gasification region is adjusted by oxygen introduction to 900 to 1100° C., in particular to 1050° C.

15. A process according to any one of claims 1 to 14 characterized in that in the reaction chamber a sub-atmospheric pressure in the range of 10 mbar to 5 bars, preferably 10 mbar is maintained.

16. A process according to any one of claims 1 to 14 characterized in that in the reaction chamber a pressure of 10 mbar to 5 bars, preferably 10 mbar is maintained.

17. A process according to any one of claims 1 to 16 characterized in that solid wastes such as municipal solid waste or hazardous wastes are gasified.

18. A process according to any one of claims 1 to 16 characterized in that sulfur-containing coal is gasified.

19. A process according to any one of claims 1 to 16 characterized in that biomass like wood is gasified.
